(19) United States
(12) Patent Application Publication
(10) Pub. No.: US 2012/0048123 A1
(43) Pub. Date: Mar. 1, 2012

(54) Steamer for foodstuffs

(76) Inventor: Jocelyn Blackburn, Alma (CA)

(21) Appl. No.: 13/064,392

(22) Filed: Mar. 23, 2011

Related U.S. Application Data
(60) Provisional application No. 61/344,570, filed on Aug. 24, 2010.

(51) Int. Cl. A47J 27/04; A47J 36/06; A47J 36/00

(52) U.S. Cl. 99/413; 99/410

(57) ABSTRACT

A steamer for foodstuffs comprises a lidded pot enclosing a stepped steaming platform adapted to support various foodstuffs at different levels dictated by the intensity and duration of their cooking requirements.

### CROSS REFERENCE TO RELATED APPLICATION

Benefit of U.S. Provisional Application for Patent Ser. No. 61/344,570 filed on Aug. 24, 2010, which is incorporated herein by reference, is hereby claimed.

### FIELD OF THE INVENTION

The present invention relates to a steamer for steam cooking of foodstuffs.

### BACKGROUND OF THE INVENTION

Steamers or inserts for pots for steam cooking and warming of foodstuffs, for example sausages and buns therefor, are well known in the art. Typically, conventional steamers comprise a bottom section, generally in the form of a pan or pot, which is placed on a source of heat and in which water is provided for boiling to generate steam for steam cooking and/or warming the foodstuffs. A top section or lid, typically removable, is configured for placement on or in the bottom section, typically in proximity to an open top end thereof, and substantially completely covering and closing off the bottom section by extending completely across the top end, thus limiting escape of steam from the steamer to accelerate cooking and warming of the foodstuffs. A steamer platform, upon which the foodstuffs are placed, is disposed within the steamer and support or otherwise maintain the foodstuffs above the water, allowing the rising steam to steam warm and cook the foodstuffs. The steamer platform may also be an insert which is inserted into a conventional pot in which water is boiled to provide the steam and which maintains the foodstuffs above the water.

Unfortunately, conventional steamers and inserts provide a number of drawbacks. For example, typically such steamers and inserts maintain all of the foodstuffs at the same vertical level above the water. Unfortunately, users often may wish to cook less, or simply warm, a first foodstuff, such as buns, which requires significantly less heat and steam, while thoroughly cooking a second foodstuff, such as sausages or meats. In such cases, keeping all of the foodstuffs at the same vertical level may often result, if the first foodstuff, for example sausages, is to be completely cooked, in the second foodstuff being oversaturated with steam and/or water, leaving them overcooked or soggy. Further, other conventional inserts suspended from the top open end of a pot often extend partially over the edges of the top end, thus preventing the lid from completely closing the pot, thus allowing steam to escape and slowing down heating and cooking. Additionally, the steaming platform of inserts often does not extend completely across the top end of the pot, which may allow foodstuffs to fall into the water. Additionally, typical steamers and inserts often require a large surface area to steam a plurality of foodstuffs.

Multi-tiered steamers for cooking foodstuffs are well known and involve the provision of a multiplicity of steaming platforms arrangeable at various levels within the steaming pot which is appropriately formed as a tower structure provided internally thereof with platform supports. A disadvantage of this approach for differential cooking regimes is the necessity to store many parts which naturally require additional cleaning.

Accordingly, there is a need for an improved steamer for foodstuffs.

### SUMMARY OF THE INVENTION

It is therefore a general object of the present invention to provide an improved steamer for foodstuffs.

An advantage of the present invention is that the steamer provides more heat and steam to a first foodstuff than a second foodstuff.

Another advantage of the present invention is that risk of immersion of the foodstuffs in the water in the steamer is reduced.

Still another advantage of the present invention is that unwanted escape of steam is minimized.

Yet another advantage of the present invention is that the steamer provides for steaming of a plurality of a plurality of foodstuffs without requiring a large surface area.

In an aspect of the present invention, there is provided a steamer comprising:
a pot having first and second side walls extending from a bottom of the pot and first and second end walls connecting the side walls and extending therebetween from the bottom, the side and end walls having a top edge defining an open top end of the pot;
a lid placeable on the top edge to cover the top end and close the pot; and
a steaming platform of steam-permeable material having an upper foodstuff platform for a first foodstuff requiring less heat and cooking and a lower basket connected thereto and extending therebelow for a second foodstuff requiring more heat and cooking, the steaming platform being removably mounted in the pot and suspending the foodstuffs, with the pot completely closed by the lid, above water boiled in the pot and providing steam for cooking the foodstuffs, the second foodstuff in the basket being situated closer to the water and receiving more of the steam than the first foodstuff to facilitate cooking thereof and reduce risk of oversaturation and overcooking of the first foodstuff with the steam.

The steaming-permeable material of the steaming platform may be constructed from a wirework mesh.

The steaming platform may conveniently be of stepped formation.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is an exploded perspective view of a steamer in accordance with a first embodiment of the present invention;

FIG. 2 is a perspective view of the steamer shown in FIG. 1, showing a steaming platform thereof disposed in a pot thereof; and

FIG. 3 is a sectional view of the frame shown in FIG. 1 taken along line 3-3 of FIG. 2.

### DETAILED DESCRIPTION OF THE PREFERRED EMBODIMENTS

With reference to the annexed drawings the preferred embodiments of the present invention will be herein described for indicative purpose and by no means as of limitation.

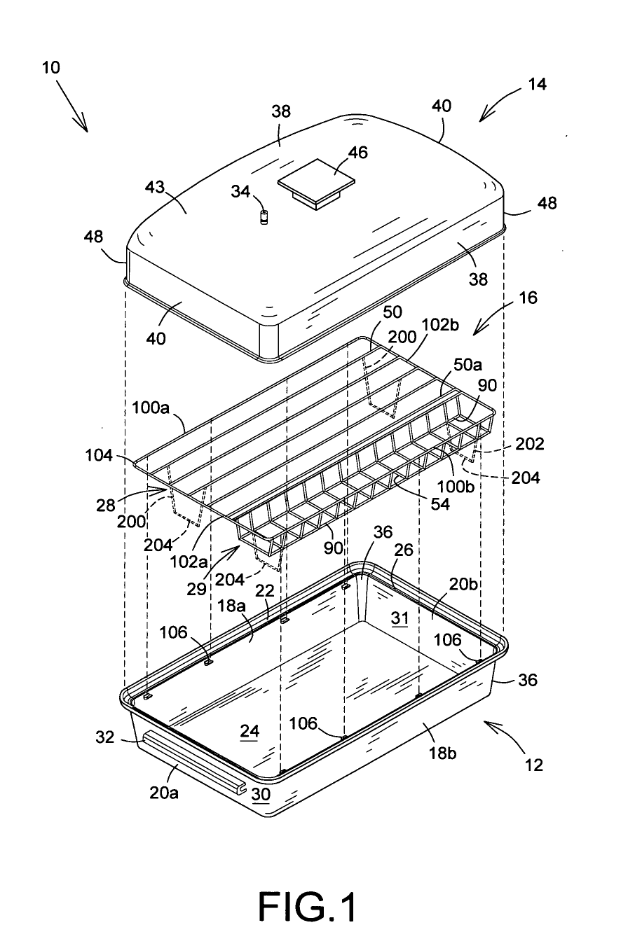

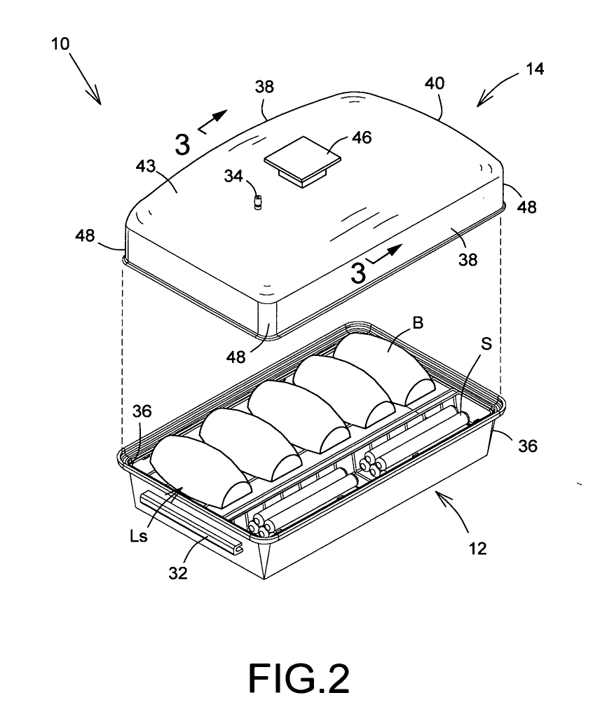

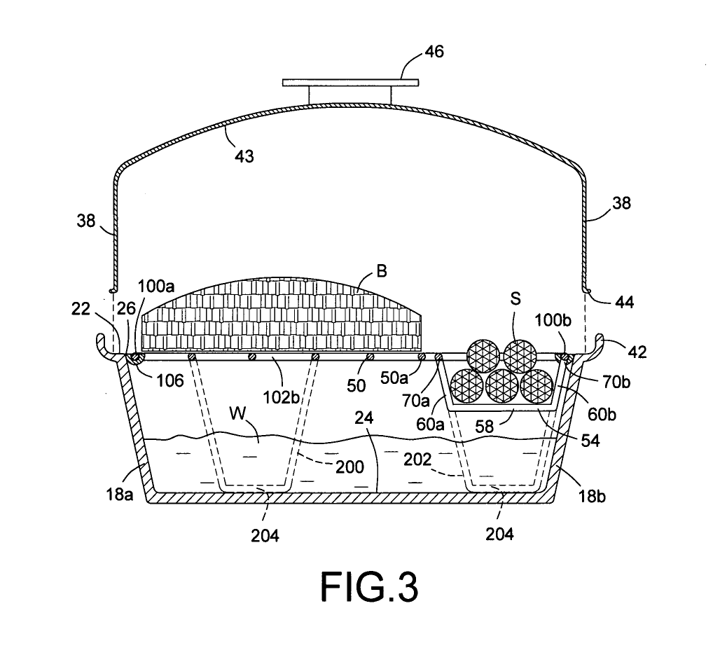

Referring now to FIGS. 1 through 3, there is shown a steamer, shown generally as 10, for steam warming or cooking a first foodstuff B, such as buns, and a second foodstuff S, for example sausages or the like. The steamer 10 consists of a pot, shown generally as 12, which is placed on, or in proximity to, a heat source, not shown. The heat source heats water W placed in the pot 12 to generate steam for steaming the foodstuffs S, B. The foodstuffs S, B are placed on a steaming platform, shown generally as 16, mounted in the pot 12 and extending above the water W preferably in proximity to a, preferably common, top edge 22 of generally opposed first and second pot side walls 18a, 18b and generally opposed first and second pot end walls 20a, 20b connected to the pot side walls 18 and extending therebetween. The pot side walls 18 and end walls 20 extend from the bottom 24 of the pot 12 and define the shape thereof, the top edge 22 generally defining an open top end 26 of the pot 12. A lid 14, placeable on the pot 12, extends completely thereacross to the top edge 22 of all of the walls 18, 20, preferably resting on the edge 22. Thus, the lid 14 completely closes the pot 12 at the top end 26, even when the steaming platform 16 is mounted therein with a full complement of first foodstuffs B and second foodstuffs S disposed therein. Accordingly, the lid 14 impedes escape of steam, which prevents steam from escaping to accelerate steaming. As the steaming platform 16 extends completely above the water W, with no part of the platform 16 immersed therein, the foodstuffs S, B disposed therein are also completely separated from the water W, which notably prevents saturation of the foodstuffs S, B with water W.

During steaming, the first foodstuff B, generally requiring less heat and cooking, sits on an upper foodstuff platform 28 of the steaming platform 16, while the second foodstuff S, generally requiring more heat and cooking, is disposed below the first foodstuff B, and therefore in closer proximity to the water W, in a basket 29, connected to the upper foodstuff platform 28 and extending therebelow. Accordingly, the second foodstuff S, for example sausages or meat, receives more heat and steam than the first foodstuff, for example buns B, which allows the second foodstuff S to be completely steamed cooked while the first foodstuff B is cooked less, for example simply warmed, by the steam, without becoming undesirably soggy due to saturation of steam. At least one pot handle 32, and preferably oppositely situated pot handles 32, extend from an outer face 30 of the pot 12, preferably at the pot end walls 20. The pot handles 32 allow for the steamer 10 to be easily displaced.

The lid 14 has two lid side walls 38 and two lid end walls 40, connecting to the lid side walls 38 and extending therebetween, which extend from the, preferably outwardly curved, roof 43 of the lid 14 and which define the shape thereof. As shown, the lid 14 is sized and shaped for partial insertion into the pot 12 with the lid walls 38, 40 generally seated on the top edge 22 and in mating abutment with an outwardly protruding pot lip 42 which protrudes slightly outwardly and upwardly from the pot walls 18, 20 at the top edge 22. More specifically, and as shown, a curved lid edge or lip 44, which extends outwardly from the lid walls 38, 40 completely around the perimeter of the lid 14 is generally seated on the top edge 22 in abutment with the pot lip 42. Accordingly, the lid 14 is insertable into the pot 14, resting generally on the top edge 22 with the lid edge 44 abutting the pot lip 42 to completely close the pot 12. The walls 38, 40 are, preferably, sized and shaped, notably in height, such that substantially all of the first foodstuffs B, for example buns, laid on a longer bottom side BS thereof may be substantially contained therein. Excess steam may be vented from the steamer 10 through the valve 34 disposed on the lid 14. The lid 14 may be easily removed using at least one lid handle 46 disposed thereon.

As shown, the pot side walls 18, preferably of identical dimensions, are preferably longer than the pot end walls 20, also preferably of identical dimensions. Accordingly, the pot 12, lid 14, and steaming platform 16 are preferably rectangular in shape. However, a generally square shape for the pot 12, lid, 14, and steaming platform 16 are also possible. Optionally, but preferably the side walls 18 and end walls 20 are also slightly slanted away from the bottom 24, with the pot corners 36 at which the walls 18, 20 connect being preferably rounded. Preferably, the lid corners 48 are also rounded. As shown, the respective lengths of the walls 18, 20, 38, 40 and steaming platform 16 are such that a plurality of items of the first foodstuffs B, for example 4 to 12 buns B, may be set on the upper foodstuff platform 28 spaced apart from one an other in a side to side configuration in which the first foodstuffs B are disposed with the bottom side BS resting, preferably entirely, on the upper foodstuff platform 28 and the lateral sides LS of the first foodstuff B generally extending in parallel alignment with the end walls 20, 40. At the same time, a plurality of items of second foodstuffs S, for example two sets of sausages S, may be stacked end to end in the basket 29.

Overall, the steaming platform 16 is sized and shaped to be mounted, for example seated, in the top end 26 of the pot 12, substantially extending thereacross between the interior of pot end walls 20 and pot side walls 18. As shown, the perimeter of the platform 16 for the embodiment shown is defined by first and second outer side members 100a, 100b and first and second outer end members 102a, 102b, which extend between the outer side members 100a, 100b and are connected thereto to form, preferably rounded, platform corners 104. The outer side members 100 are sized and shaped to extend proximally adjacent and alongside the interior of the pot side walls 18a, 18b in proximity of the top edge of the pot 12. Similarly, the outer end members 102a, 102b are sized and shaped to extend alongside and proximally adjacent the interior face 31 of the pot end walls 20a, 20b in proximity of the top edge 22 of the pot 12. Accordingly, the steaming platform 16 is of the same general shape and size as the interior face 31 of the pot 12 at the top edge 22 thereof, and preferably rectangular for the embodiment shown. Thus, the steaming platform 16 can easily be set into the pot 12 and mounted therein in spaced apart hooks 106, preferably disposed on the interior face 31 of each of the pot side walls 18 in proximity to, and preferably vertically aligned with, the top edge 22, each pot side wall 18 having, preferably, at least two hooks 106. However, it should be noted that, hooks 106 could also be disposed on the interior face 31 of the pot end walls 20. As shown, the steaming platform 16 can be removed from the pot 12 to allow serving of the foodstuffs S, B, as well as cleaning of the steam platform, lid 14, and pot 12. Alternatively, the hooks 106 may be omitted and the steaming platform 16 may instead be provided with a set of longer support legs 200 and shorter support legs 202. The longer support legs 200 extend downwardly from inner side members 50, one longer support leg 200 extending proximal each outer end member 102 and preferably parallel thereto. The shorter support legs 202 extend from the bottom portion 58 of the basket, one shorter support leg 202 situated proximal each outer end member 102 and extending preferably parallel thereto. The bottoms 204 of the legs 200, 202 are vertically aligned with one another and are sized and shaped such that the steaming platform 16 can easily be set into the pot 12 and mounted therein with legs supporting the platform 16 on the bottom 24 of the pot 12 and the platform 16 vertically aligned with the top edge 22, as shown. The steaming platform 16 can be removed from the pot 12 to allow serving of the foodstuffs S, B, as well as cleaning of the steam platform, lid 14, and pot 12.

The upper foodstuff platform 28, also preferably rectangular in shape, is formed from a plurality of spaced apart inner side members 50, in conjunction with first outer side member 100a, from which inner side members 50 are also spaced apart, and the outer end members 102. The side members 50 are substantially straight and extend from the first outer end member 102a to the second outer end member 102b, preferably in parallel alignment with the outer side members 100. Thus, the upper foodstuff platform 28 is sized and shaped to extend substantially across the pot 12 at the edge 22, in parallel alignment with the pot side walls 20. As shown, the overall dimensions, and notably the length of the upper foodstuff platform 28 relative the outer end members 102, are preferably at least as long as the bottom side BS of the first foodstuffs B, which allows placement of the first foodstuffs B, for example buns, extending side to side thereon with the side members 50, 100a extending transversely across the bottom side BS thereof to hold the foodstuffs B above the water W.

The basket 29 is formed by a plurality of basket members 54 disposed on the steaming platform 16 in a, preferably equally, spaced apart relationship between the outer end members 102. Each basket member 54 is formed of a bottom portion 58 extending between first and second vertical portions 60a, 60b which are preferably substantially equal in length and extend upwardly and outwardly, preferably on a slant, away from the bottom portion 58 to, respectively first and second basket member ends 70a, 70b. The first vertical portions 60a of the basket members 52 are each connected and to an adjacent, or outermost, inner side member 50a on their first basket ends 70a, the adjacent inner side member 50a defining the inner edge of the upper foodstuff platform 28. The second vertical portions 60b are connected to the second outer side member 100b at basket member ends 70b. Accordingly, the basket members 54 extend radially, downwardly away from the side members 50a, 100b, preferably in parallel alignment with one another and the pot end walls 20. Thus, the basket 29 is connected to the upper foodstuff platform 28 at the adjacent inner side member 50a, with the basket members 54 extending downwardly therefrom on the first vertical portions 60a, then across from the vertical portions along the bottom portions 58, and then upwardly along the second vertical portions 60b to the outer side member 100b to form the basket 29, downwardly recessed from the upper foodstuff platform 28. As the basket members 54 extend radially from the side members 50a, 100b between the end members 102 and end walls 20, they allow a plurality of items of foodstuffs S, and possibly a plurality of sets of foodstuffs S, to be stacked therein in an end-to-end configuration in which the basket members 54 extend transversely below the foodstuffs S and maintain them above the water W, at a greater degree of proximity thereto than the foodstuffs B. Thus, and as described previously, the foodstuffs S are exposed to more heat and steam than foodstuffs B. Advantageously, the spacing apart of the members 50, 54, 100, 102 also allows for facilitated and improved distribution of steam within the steamer and facilitates steaming.

The members 50, 54, 100, 102 are, preferably, round in shape, as are the hooks 106. However, other shapes are possible, provided that the steaming platform 16 can be placed on, i.e. mounted in, the hooks 106. Further, if desired, the basket 29 may have cross members 90 extending between and connecting adjacent basket members 54 at the intersections of the bottom portions 50 and vertical portions 60. The pot 12, lid 14, and members 50, 54, 100, 102 may be constructed of any material conventionally used for cookwares, such as stainless steel, ceramic, aluminum, or the like.

While the foodstuffs S, B shown are sausages and buns, the steamer 10 may be used with any foodstuffs that may be appropriate for steam cooking or warming, for example vegetables, meats, breads, or others. In particular, the steamer will be particularly useful for use with first or second foodstuffs in which the first foodstuff, placed on platform 16, requires less heat or steam than the second foodstuffs placed in basket 29.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A steamer for foodstuffs comprising:
a pot having first and second side walls extending from a bottom of the pot and first and second end walls connecting the side walls and extending therebetween from the bottom, the side and end walls having a top edge defining an open top end of the pot;
a lid placeable on the top edge to cover the top end and close the pot; and
a steaming platform of steam-permeable material having an upper foodstuff platform for a first foodstuff requiring less heat and cooking and a lower basket connected thereto and extending therebelow for a second foodstuff requiring more heat and cooking, the steaming platform being removably mounted in the pot and suspending the foodstuffs, with the pot completely closed by the lid, above water boiled in the pot and providing steam for cooking the foodstuffs, the second foodstuff in the basket being situated closer to the water and receiving more of the steam than the first foodstuff to facilitate cooking thereof and reduce risk of oversaturation and overcooking of the first foodstuff with the steam.

2. A steamer according to claim 1 wherein the top edge defining the open top end of the pot is provided with an outwardly protruding pot lip which protrudes from the pot walls to define a ledge, and the lid is provided with a curved lip adapted to register on the ledge within the pot.

3. A steamer according to claim 1 wherein the steaming platform is sized and shaped to be seated in the top end of the pot.

4. A steamer according to claim 3 wherein the pot has an interior face on which is provided a plurality of supports for supporting the steaming platform.

5. A steamer according to claim 4 wherein the supports are in the form of hooks.

6. A steamer according to claim 3 wherein the pot has four interior faces on at least two opposing faces of which is provided a plurality of supports for supporting the steaming platform.

7. A steamer according to claim 6 wherein the supports are in the form of hooks.

8. A steamer according to claim 3 wherein the steaming platform is provided with depending support legs which are adapted in use to contact the base of the pot and thereby support the platform.

9. A steamer according to claim 8 wherein the legs depending from the basket of the steaming platform are shorter than the legs depending from the upper foodstuff platform.

10. A steamer according to claim 1 wherein the steam-permeable material of the steaming platform is constructed of a wirework mesh.

11. A steamer according to claim 1 wherein the steaming platform is of stepped formation.
